(19) United States
(12) Patent Application Publication
(10) Pub. No.: US 2025/0051598 A1
(43) Pub. Date: Feb. 13, 2025

(54) INK JET RECORDING METHOD AND INK JET RECORDING APPARATUS

(71) Applicant: CANON KABUSHIKI KAISHA, Tokyo (JP)

(72) Inventors: ERIKO YOSHINO, Kanagawa (JP); SOICHI NAGAI, Kanagawa (JP); ATSUHITO YOSHIZAWA, Tokyo (JP); YUKO NISHIWAKI, Tokyo (JP)

(21) Appl. No.: 18/796,751

(22) Filed: Aug. 7, 2024

(30) Foreign Application Priority Data
Aug. 7, 2023 (JP) 2023-128301
Jul. 23, 2024 (JP) 2024-117456

(51) Int. Cl. C09D 11/322; B41J 2/175; B41J 2/21; C09D 11/38

(52) U.S. Cl. CPC C09D 11/322; B41J 2/17513; B41J 2/2107; C09D 11/38

(57) ABSTRACT

Provided is an ink jet recording method with which, even when a downsized recording apparatus having mounted thereon a recording unit in which a recording head for ejecting an ink by thermal energy is incorporated into an ink storage portion is used and an aqueous ink containing a pigment is used, while the strength of the recording unit is maintained, an ejection characteristic is less liable to be degraded and an image excellent in color developability can be recorded. The ink jet recording method includes recording an image through use of an ink jet recording apparatus including an aqueous ink, an ink storage portion, and a recording head. The ink storage portion includes three or more storage parts divided independently, and the storage parts are arrayed in one predetermined direction. A yellow ink containing C.I. Pigment Yellow 74 is stored in the storage part arranged on an inner side.

### BACKGROUND OF THE INVENTION

### Field of the Invention

The present invention relates to an ink jet recording method and an ink jet recording apparatus.

### Description of the Related Art

In recent years, there is an increasing demand for an ink jet recording apparatus for household use due to an increase of remote work at home and the like. Further, for household use, the ink jet recording apparatus is desired to be further downsized. For downsizing of the ink jet recording apparatus, downsizing of a recording head and an ink storage portion is essential. For example, there is known an ink jet recording apparatus having mounted thereon a recording unit downsized by integrating the ink storage portion and the recording head with each other.

Some of those ink jet recording apparatus adopt a recording head employing a system of ejecting ink by an action of thermal energy from the viewpoint that the ink jet recording apparatus can be designed to be more downsized. Further, the recording head has been devised to be downsized by providing ejection orifice arrays for ejecting respective inks of a plurality of colors in the same recording element substrate. Moreover, some recording units are downsized by bonding the recording head to the ink storage portion without intermediation of any other member. In addition, the apparatus is downsized by forming the ink storage portion from a thermoplastic resin to reduce the weight of the recording unit, and decreasing the rigidity required for a carriage portion.

However, the ink storage portion formed from only a thermoplastic resin has problems of being liable to be deformed and being liable to crack due to an external pressure such as an impact applied by falling. In order to solve such problems, there has been proposed an ink storage container formed from a material obtained by adding a filler material such as a glass filler to a thermoplastic resin so that a linear expansion coefficient is reduced (Japanese Patent Application Laid-Open No. 2008-142935). In a case of an ink jet recording apparatus for use in business such as remote work at home, there has been a demand for a high level of permanence even for a color image, and hence a pigment ink using a pigment as a coloring material has been suitably used.

The inventors of the present invention have verified the ink storage portion formed from a thermoplastic resin composition containing a filler material, which has been proposed in Japanese Patent Application Laid-Open No. 2008-142935. Specifically, an ink jet recording apparatus having mounted thereon a recording unit formed by bonding a recording head for ejecting an ink by the action of thermal energy to the above-mentioned ink storage portion (hereinafter also simply referred to as “recording unit”) was prepared. Then, an image was recorded through use of the above-mentioned ink jet recording apparatus in which an aqueous ink containing a pigment was stored in the ink storage portion. As a result, it was found that an ejection accuracy of a yellow ink containing C.I. Pigment Yellow 74 was reduced along with an increase in the cumulative number of times of ejection, and thus ejection misdirection, deformation of a dot shape or the like was liable to be caused. It was found that the reduction in ejection accuracy was remarkedly caused particularly when the recording head was driven at a high frequency. When the ejection misdirection or the deformation of the dot shape occurs and the ejection accuracy is reduced, in a recording medium, there occurs a phenomenon, such as deviation of an ink application position from an intended position or a dot not having a circular shape, resulting in reduction in image quality.

As a result of further verification, when a dye ink containing a dye as a coloring material was used, reduction in ejection accuracy was not observed. Further, an ink storage portion formed from a thermoplastic resin containing no filler material was prepared. Then, an ink jet recording apparatus having mounted thereon a recording unit obtained by bonding a recording head to this ink storage portion was used. As a result, no reduction in ejection accuracy was observed. Moreover, a recording unit obtained by bonding a recording head for ejecting an ink by the action of mechanical energy through use of a piezoelectric element to an ink storage portion formed from a thermoplastic resin composition containing a filler material was prepared. Then, an ink jet recording apparatus having this recording unit mounted thereon was used. As a result, no reduction in ejection accuracy was observed.

### SUMMARY OF THE INVENTION

Thus, the present invention has an object to solve problems caused when a recording apparatus having mounted thereon a recording unit in a form in which a recording head is incorporated into an ink storage portion formed from a thermoplastic resin composition containing a filler material is used and an aqueous ink containing a pigment is used. That is, the present invention has an object to provide an ink jet recording method with which, when such a downsized recording apparatus is used and the aqueous ink is ejected by the action of thermal energy, while the strength of the recording unit is maintained, an ejection characteristic is less liable to be degraded and an image excellent in color developability can be recorded. Further, the present invention has another object to provide an ink jet recording apparatus to be used in this ink jet recording method.

That is, according to the present invention, there is provided an ink jet recording method using an ink jet recording apparatus, the ink jet recording apparatus including: an aqueous ink containing a pigment; an ink storage portion which is configured to store the aqueous ink, and is formed from a thermoplastic resin composition containing a filler material; and a recording head to be bonded to the ink storage portion, the recording head having formed therein an ejection orifice configured to eject the aqueous ink supplied from the ink storage portion by an action of thermal energy, the ink jet recording method including recording an image by applying the aqueous ink ejected from the ejection orifice to a recording medium. The ink storage portion includes three or more storage parts divided independently of each other, and the three or more storage parts are arrayed in one predetermined direction. The aqueous ink includes a yellow ink containing C.I. Pigment Yellow 74. The yellow ink is stored in a corresponding one of the three or more storage parts arranged on an inner side.

According to the present invention, it is possible to solve problems caused when the recording apparatus having mounted thereon the recording unit in a form in which the recording head is incorporated into the ink storage portion formed from the thermoplastic resin composition containing the filler material is used and the aqueous ink containing the pigment is used. That is, the ink jet recording method with which, when such a downsized recording apparatus is used and the aqueous ink is ejected by the action of thermal energy, while the strength of the recording unit is maintained, the ejection characteristic is less liable to be degraded and an image excellent in color developability can be recorded can be provided. Further, according to the present invention, the ink jet recording apparatus to be used in this ink jet recording method can be provided.

Further features of the present invention will become apparent from the following description of exemplary embodiments with reference to the attached drawings.

### BRIEF DESCRIPTION OF THE DRAWINGS

FIG. 1 is a perspective view for schematically illustrating an ink jet recording apparatus according to one embodiment of the present invention.

FIG. 2 is a perspective view for schematically illustrating an internal structure of the ink jet recording apparatus according to one embodiment of the present invention.

FIG. 3 is a view for schematically illustrating an example of a recording unit. (a) is a perspective view, and (b) is a perspective view of an exploded state.

FIG. 4 is a view for schematically illustrating an example of the recording unit. (a) is a view as viewed from above with a tank lid being removed, and (b) is a view as viewed from below.

FIG. 5 is a view for schematically illustrating another example of the recording unit. (a) is a view as viewed from above with the tank lid being removed, and (b) is a view as viewed from below.

FIG. 6 is a schematic view for illustrating an example of a sucking unit.

FIG. 7A is a schematic view for illustrating an example of an array mode of storage parts.

FIG. 7B is a schematic view for illustrating another example of the array mode of the storage parts.

FIG. 7C is a schematic view for illustrating another example of the array mode of the storage parts.

FIG. 7D is a schematic view for illustrating another example of the array mode of the storage parts.

FIG. 7E is a schematic view for illustrating another example of the array mode of the storage parts.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink for ink jet is sometimes simply referred to as “ink”. Physical property values are values at normal temperature (25° C.) unless otherwise stated.

The inventors of the present invention have prepared an ink jet recording apparatus having mounted thereon a recording unit in which a recording head for ejecting an ink by the action of thermal energy was incorporated into an ink storage portion formed from a thermoplastic resin composition containing a filler material. Then, the inventors of the present invention have verified causes of degradation of an ejection characteristic of a yellow ink containing C.I. Pigment Yellow 74 at the time of high frequency drive of the recording head along with an increase in the cumulative number of times of ejection when this ink jet recording apparatus was used.

The recording unit in the form in which the recording head is incorporated into the ink storage portion formed from the thermoplastic resin composition containing the filler material is normally stored under a state in which the ink storage portion is filled with the ink, and the recording unit is set to the ink jet recording apparatus at the time of starting usage of the apparatus. As a result of the verification, it was found that an inorganic metal, such as calcium (Ca), magnesium (Mg), iron (Fe) and aluminum (Al), was liable to be eluted from the filler material during storage to be dissolved into the ink. When an inorganic metal is dissolved in the ink, the dispersed state of the pigment becomes unstable. Further, in the case of the recording head for ejecting the ink by the action of thermal energy, the ink is increased in temperature at the time of foaming, and hence the dispersed state of the pigment further becomes unstable, and the pigment is liable to aggregate. In this case, when a dye ink was used, no degradation of the ejection characteristic was observed. The reason therefor is considered to be because a dye ink is less liable to become unstable even when an inorganic metal is dissolved therein.

Further, it cannot be said that a gas barrier property of the ink storage portion formed from the thermoplastic resin composition containing the filler material is always high. Accordingly, the following can also be considered as causes of reduction in ejection characteristic. That is, a liquid component such as water in the ink stored in the ink storage portion gradually evaporates so that the concentration of the pigment in the ink relatively increases. Thus, the dispersion state of the pigment becomes unstable, or the sedimentation of the pigment may be promoted.

C.I. Pigment Yellow 74 has a low heat resistance, and hence, in some cases, after being partially dissolved by the action of heat generated by a heater used for ejecting the ink, C.I. Pigment Yellow 74 may be cooled to be crystallized and then precipitated. An aggregate is generated originally from a precipitate of the pigment generated as described above, and gradually adheres to a flow path of the ink. As a result, a flow path width is narrowed, and the supply of the ink becomes insufficient particularly at the time of high frequency drive to cause ejection misdirection or deformation of a dot shape. This is how the ejection accuracy is considered to be reduced. In addition, as a result of further verification, it has been found that the reduction in ejection accuracy described above was remarkedly caused due to progress of evaporation of a liquid component such as water in the ink. It is considered that the content of the pigment of the ink relatively rises due to the evaporation of the liquid component such as water, and thus the amount of the adhering substance increases to cause remarkable reduction in ejection accuracy.

As a result of verification, the inventors of the present invention produced an ink storage portion which included three or more storage parts divided independently of each other and in which those storage parts were arrayed in one predetermined direction. In addition, a cyan ink, a magenta ink and a yellow ink were stored in the respective storage parts arrayed in one row, and the ink storage portion was left under a condition that easily caused the ink to evaporate. After that, the evaluation of the ejection characteristic was carried out. As a result of those verifications, it has been found that the occurrence of the reduction in ejection accuracy could be suppressed by storing the yellow ink containing C.I. Pigment Yellow 74 in the storage part arranged on the inner side. Thus, the present invention has been made. When three or more storage parts are arrayed in one direction, water moves from each of the storage parts arranged on both sides to the storage part arranged on the inner side, and the content of water in the ink stored in the storage part arranged on the inner side is slightly increased (is humidified). Further, the storage part arranged on the inner side has a relatively small contact area with external air, and hence the water in the stored ink is less liable to evaporate as compared to the storage parts arranged on both sides. In addition, it is considered that the reduction in ejection accuracy can be suppressed by storing the yellow ink containing C.I. Pigment Yellow 74 that is liable to aggregate due to the evaporation of the liquid component such as water in the storage part arranged on the inner side.

### <Ink Jet Recording Method and Ink Jet Recording Apparatus>

The ink jet recording method of the present invention is a recording method using an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion by an action of thermal energy is formed. In addition, the ink jet recording method of the present invention includes a step of recording an image by applying the ink ejected from the ejection orifice to a recording medium. The ink storage portion includes three or more storage parts divided independently of each other, and those storage parts are arrayed in one predetermined direction. In addition, the ink includes a yellow ink containing C.I. Pigment Yellow 74, and this yellow ink is stored in the storage part arranged on the inner side.

Further, the ink jet recording apparatus of the present invention is an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion by an action of thermal energy is formed. The ink storage portion includes three or more storage parts divided independently of each other, and those storage parts are arrayed in one predetermined direction. In addition, the ink includes a yellow ink containing C.I. Pigment Yellow 74, and this yellow ink is stored in the storage part arranged on the inner side.

### (Ink Jet Recording Apparatus)

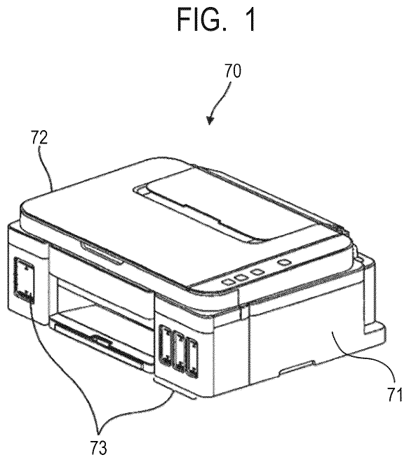

FIG. 1 is a perspective view for schematically illustrating an ink jet recording apparatus according to one embodiment of the present invention. As illustrated in FIG. 1, an ink jet recording apparatus 70 of this embodiment includes an outer package 71 and a cover member 72 arranged on the upper surface of the outer package 71. The cover member 72 is a member that is openable and closable in a vertical direction, and its opening in an upper direction enables the observation of the inside of the ink jet recording apparatus 70 having a rectangular parallelepiped shape.

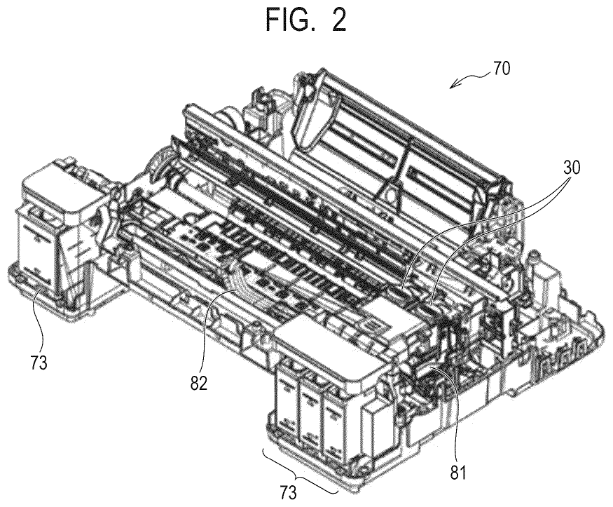

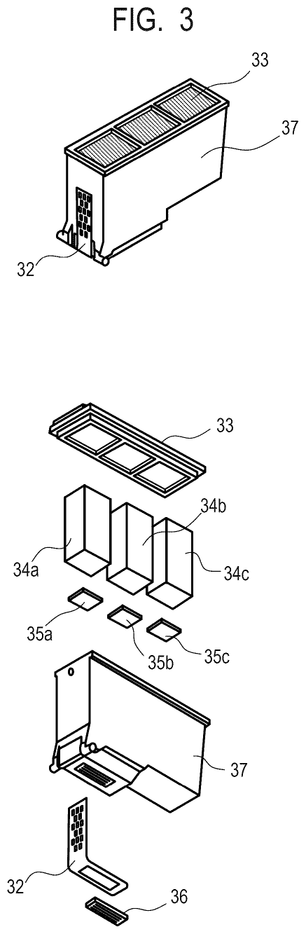

FIG. 2 is a perspective view for schematically illustrating the internal structure of the ink jet recording apparatus according to one embodiment of the present invention. A recording unit 30 in which a recording head and an ink storage portion are integrally formed is configured to be mountable to a carriage (support member) 81. The recording unit 30 is provided on the carriage by being coupled to a joint (not shown) provided at an upper portion of the carriage 81. The recording unit 30 is coupled to a tube 82 which is a flexible member, and another end of the tube 82 is coupled to a main tank (second ink storage portion) 73 which is a second ink storage portion. When the recording unit 30 is mounted to the carriage 81, a recording head 36 ((b) in FIG. 3) is allowed to communicate with the main tank 73 via the joint and the tube 82. The ink jet recording apparatus 70 of this embodiment is a recording apparatus of a serial scan type, and the carriage 81 is guided to be movable in a main scanning direction by a guide shaft. The carriage 81 reciprocates in the main scanning direction by a carriage motor and a drive force transmission mechanism such as a belt for transmitting a drive force of the carriage motor (both not shown).

A recording medium is conveyed by a conveyance roller in a sub-scanning direction orthogonal to the main scanning direction of the carriage 81. The ink jet recording apparatus 70 repeatedly performs a recording operation of ejecting an ink toward a recording region of the recording medium on a platen while moving the recording head 36 ((b) in FIG. 3) in the main scanning direction, and a conveying operation of conveying the recording medium in the sub-scanning direction by a distance corresponding to its recording width. In this manner, an image is sequentially recorded on the recording medium.

FIG. 3 is a view for schematically illustrating an example of the recording unit. (a) is a perspective view, and (b) is a perspective view of an exploded state. The recording unit illustrated in FIG. 3 includes an ink storage portion 37 and the recording head 36. The ink storage portion 37 is a casing formed from a thermoplastic resin composition containing a filler material. Examples of the thermoplastic resin composition include polyester, polycarbonate, polypropylene, polyethylene, polystyrene, polyphenylene ether and mixtures or modified substances of them. Examples of the filler material include a flake filler such as mica and a fibrous filler such as a glass fiber. A general glass fiber is a glass fiber (chopped strand) made of a material called E-glass (non-alkali glass) in a form of being cut into a predetermined length. The recording head 36 is preferably bonded to the ink storage portion 37 without through intermediation of any other member. The ink storage portion 37 has a light weight because the portion is a casing formed from a thermoplastic resin composition. The entirety of the recording unit is reduced in size and weight because the recording head 36 is bonded to the ink storage portion 37 without through intermediation of any other member such as a heat-radiating plate. The use of such recording unit can reduce the size and weight of the entirety of the ink jet recording apparatus. The heat-radiating plate may be, for example, a plate formed from a material such as a metal oxide such as alumina. Further, the ink storage portion 37 formed from the thermoplastic resin composition containing the filler material has a linear expansion coefficient lower than that of a member formed from a thermoplastic resin containing no filler material. Accordingly, deformation of the casing can be suppressed, and occurrence of cracking due to an external pressure such as falling can be suppressed.

The recording head 36 has arranged therein, for example, a plurality of ejection orifices that ejects the ink and a thermal energy-generating element that generates thermal energy for ejecting the ink. The thermal energy-generating element may be driven by, for example, electric power supplied through an electrical wiring member 32. The thermal energy-generating element is an element that generates thermal energy, and the action of the generated thermal energy can eject the ink from the ejection orifices. Examples of the element that generates thermal energy include an electrothermal converter.

The recording head 36 includes an ejection orifice surface in which a plurality of ejection orifice arrays each formed of a plurality of ejection orifices is arrayed in the same recording element substrate. When the plurality of ejection orifice arrays is arrayed in the same recording element substrate, a plurality of inks can be ejected by one recording unit, and thus the ink jet recording apparatus can be downsized. The plurality of ejection orifice arrays is preferably arrayed in a direction (sub-scanning direction) orthogonal to a reciprocating direction (main scanning direction) of the recording unit into which the recording head is incorporated. Further, with the ejection orifice array being formed of the plurality of ejection orifices, a recordable region at the time of reciprocating the recording head can be enlarged, and hence fast recording can be performed.

Sponge-like ink absorbers 34a to 34c are stored in the ink storage portion 37. In addition, filters 35a to 35c are arranged below the ink storage portion 37 in a gravity direction. When a negative pressure is generated by utilizing the capillary forces of the sponge-like ink absorbers 34a to 34c, the ink can be prevented from leaking from the ejection orifices. In addition, the arrangement of the filters 35a to 35c can suppress the entry of fine foreign matter such as dirt into the ejection orifices. Further, provision of a tank lid 33 by thermocompression bonding on an upper side of the ink storage portion 37 in the gravity direction can prevent the ink from leaking from the ink storage portion 37.

The recording head preferably includes a warming unit for warming the ink in the recording head. The warming unit only needs to be a unit that can warm the ink in the recording head to a temperature higher than a recording environment temperature such as a room temperature (25° C.). Examples of such warming unit may include: a heater for ink temperature control arranged so as to be brought into contact with the recording head; and a heater for ink ejection. To warm the ink with the heater for ink ejection, for example, such a current that the ink is not ejected can be repeatedly passed through the heater.

The ink jet recording apparatus further preferably includes a second ink storage portion and a tube. The second ink storage portion such as a main tank has a capacity larger than that of the ink storage portion (first ink storage portion) such as a sub tank. The tube allows the ink to flow between the second ink storage portion and the ink storage portion. In consideration of a usage mode or the like in remote work at home, reduction in replacement frequency of an ink cartridge is also important in addition to downsizing of the apparatus. Accordingly, further provision of the second ink storage portion such as the main tank can reduce the ink replacement frequency while the increase in size of the apparatus main body is avoided. In the following, an ink jet recording apparatus in which only the first ink storage portion such as the sub tank bonded to the recording head is provided as the ink storage portion is also referred to as “first apparatus configuration.” In the case of the first apparatus configuration, when the ink stored inside of the ink storage portion has been consumed, the ink storage portion is replaced with another ink storage portion (ink storage portion filled with an ink). Thus, as compared to a second apparatus configuration, the main tank and the tube can be omitted, and thus the weight of the ink jet recording apparatus can be reduced. Further, an ink jet recording apparatus in which the second ink storage portion such as the main tank having a capacity larger than that of the sub tank is further provided as the ink storage portion is also referred to as “second apparatus configuration.” In the case of the second apparatus configuration, for example, when a connection portion for a tube is formed in the tank lid 33 illustrated in FIG. 3, the ink storage portion 37 and the second ink storage portion such as the main tank can be connected to each other.

In the case of the second apparatus configuration, the ink replacement frequency is reduced as compared to the first apparatus configuration, and hence a period in which an ink in a stationary state is kept in the main tank becomes long. Further, in a case of a pigment ink, when the period in which the ink is kept in the stationary state becomes long, the pigment is liable to be settled. Degradation of an ejection property caused by sticking occurs because the ink dries in the flow path and the pigment aggregates. Thus, the degradation of the ejection property becomes more remarkable as an ink having a larger content of the pigment is used. In addition, the ejection characteristic of the second apparatus configuration is more liable to be degraded than the ejection characteristic of the first apparatus configuration depending on the usage state. In particular, when an ink containing C.I. Pigment Yellow 74 is ejected from a recording head utilizing thermal energy, the ejection characteristic is liable to be remarkedly degraded. In contrast, in the ink jet recording method of the present invention, both of the reduction in ink replacement frequency and the improvement in ejection characteristic can be achieved.

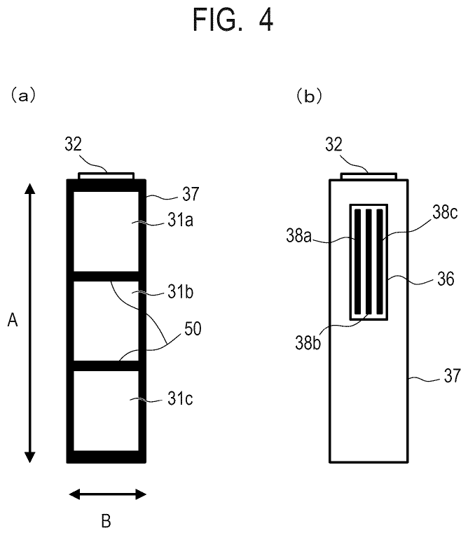

FIG. 4 is a view for schematically illustrating an example of the recording unit. (a) is a view as viewed from above with the tank lid being removed, and (b) is a view as viewed from below (recording head side). As illustrated in FIG. 4, the ink storage portion 37 includes three or more storage parts 31a to 31c divided independently of each other. Those storage parts 31a to 31c are divided by, for example, partition portions 50 formed from the same material as the casing, and are capable of individually storing a plurality of kinds of inks. Further, the recording head 36 includes an ejection orifice surface in which a plurality of ejection orifice arrays 38a to 38c each formed of a plurality of ejection orifices is arrayed in the same recording element substrate. Those ejection orifice arrays 38a to 38c correspond to the plurality of kinds of inks individually stored in the storage parts 31a to 31c, respectively. In addition, the storage parts 31a to 31c are arrayed in one predetermined direction, and the yellow ink containing C.I. Pigment Yellow 74 is stored in the storage part 31b arranged on the inner side among the storage parts 31a to 31c. The storage part 31b arranged on the inner side has a relatively small contact area with the external air, and hence water is less liable to evaporate from the stored yellow ink as compared to the storage parts 31a and 31c arranged on both sides. Further, water moves from each of the storage parts 31a and 31c arranged on both sides to the storage part 31b arranged on the inner side, and hence the content of water in the yellow ink stored in the storage part 31b is slightly increased (is humidified). In this manner, it is considered that the aggregation of C.I. Pigment Yellow 74 in the yellow ink stored in the storage part 31b can be suppressed, and thus the reduction in ejection accuracy of the yellow ink can be suppressed.

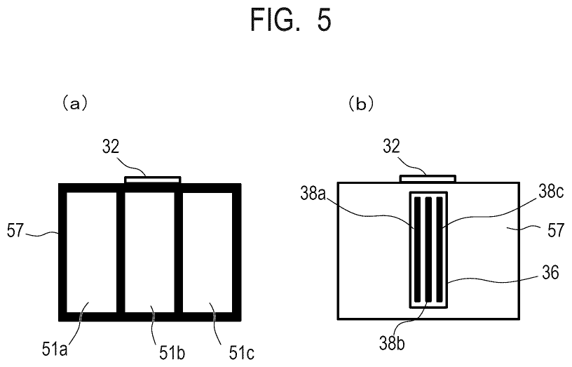

FIG. 5 is a view for schematically illustrating another example of the recording unit. (a) is a view as viewed from above with the tank lid being removed, and (b) is a view as viewed from below (recording head side). An ink storage portion 57 illustrated in FIG. 5 includes three or more storage parts 51a to 51c divided independently of each other, and those storage parts 51a to 51c are arrayed in one predetermined direction. An array direction of the plurality of storage parts only needs to be one direction in a predetermined direction. For example, the storage parts may be arrayed in a direction orthogonal to the main scanning direction of the recording head 36 as illustrated in FIG. 4, or may be arrayed in a direction parallel to the main scanning direction of the recording head 36 as illustrated in FIG. 5. From the viewpoint of the strength of the ink storage portion, the array direction of the plurality of storage parts is particularly preferably the array direction orthogonal to the main scanning direction of the recording head 36.

In the ink storage portion, a ratio (A/B) of a length A in a longitudinal direction (sub-scanning direction) to a length B in a transverse direction (main scanning direction) is preferably 2.0 times or more to 4.0 times or less ((a) in FIG. 4). When the ratio A/B is set to 2.0 times or more, a compact apparatus width can be achieved. In order to record an image on the entire surface of the recording medium through use of a so-called serial type ink jet recording apparatus in which the image is recorded while the recording head scans back and forth in the main scanning direction orthogonal to the conveying direction of the recording medium, it is required to move the ejection orifice array from one end to another end of the recording medium. When the width of the recording head is wide, the width of the ink jet recording apparatus becomes inevitably wide. Further, in a case in which the ratio A/B of the ink storage portion is excessively large, when an external force is applied to the casing, the stress concentrates in the longitudinal direction, and, in some cases, deformation due to the insufficient strength of the casing may occur. Accordingly, the ratio A/B is preferably 4.0 times or less.

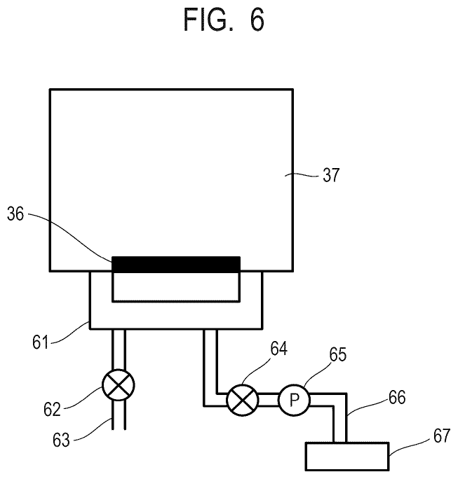

FIG. 6 is a schematic view for illustrating an example of a sucking unit. As illustrated in FIG. 6, the ink jet recording apparatus includes a cap 61 for covering the plurality of ejection orifice arrays in abutment against a region including the ejection orifice surface of the recording head 36. A tube 63 and a waste ink tube 66 are connected to the cap 61. The tube 63 functions as an atmosphere communicating portion, and the waste ink tube 66 discharges a waste ink not used for recording, which is accumulated in the cap 61. In the middle of the tube 63, an atmosphere communicating valve 62 is provided. The waste ink discharged from the ejection orifice of the recording head 36 is stored in a waste ink storage portion 67. A suction valve 64 is provided in the middle of the waste ink tube 66, and a sucking operation for discharging the unrequired waste ink is carried out through use of a pump 65. In this embodiment, description has been given of an example of a sucking operation in which the pump provided on a downstream side of the recording head is used, but the waste ink not used for recording may be discharged from the ejection orifice by a pressurizing operation using a pump provided on an upstream side of the recording head.

For example, when it becomes difficult to normally eject an ink because the ink dries and sticks in a flow path or the like communicating with the ejection orifice, the sucking operation is carried out to cause a new ink to flow from the ink storage portion 37. Thus, the state in which the normal ejection is difficult can be solved. Normally, when the plurality of ejection orifice arrays is arrayed in the same recording element substrate, the sucking operation is carried out with the same cap. For example, when the ejection orifice arrays for respectively ejecting a cyan ink, a magenta ink and a yellow ink are arrayed in the same recording element substrate, those inks are collectively sucked with the same cap. In general, when an ink for which sticking can be easily solved and an ink for which sticking cannot be easily solved are mixed, although the sticking of the ejection orifice for ejecting the ink for which sticking can be easily solved is solved, the sucking operation for the ink for which sticking cannot be easily solved needs to be continued, and thus the anti-sticking property is reduced. In addition, in some cases, a waste ink amount of an ink having a low ejection characteristic is liable to increase.

### (Aqueous Ink)

In the ink jet recording method of the present invention, an ink containing a pigment is used. The method includes a step of recording an image by applying the ink ejected from an ejection orifice to a recording medium. The ink includes a yellow ink. In addition, the ink generally further includes an ink having a hue other than yellow. Examples of the ink having a hue other than yellow may include the magenta ink and the yellow ink. Now, components for forming the ink and the like are described. When there is no need to distinguish the cyan ink, the magenta ink and the yellow ink from each other, the inks are collectively referred to as “ink.” The inks of the respective colors may have the same configuration or have different configurations within a range of the preferable mode described below.

### Coloring Material

As a coloring material of the ink, a pigment is used from the viewpoint of improving the permanence of the image. As a yellow ink to be stored in the storage part arranged on an inner side among the three or more storage parts arrayed in one predetermined direction, C.I. Pigment Yellow 74 needs to be used.

Examples of the pigment may include organic pigments, such as an azo pigment, a phthalocyanine pigment, a quinacridone pigment, an isoindolinone pigment, an imidazolone pigment, a diketopyrrolopyrrole pigment and a dioxazine pigment. C.I. Pigment Yellow 74 serving as an azo pigment is used as a pigment of the yellow ink. As a pigment of any other ink (a cyan ink or a magenta ink) that may be used together with the yellow ink, a phthalocyanine pigment, a dioxazine pigment, a quinacridone pigment, an azo pigment or a diketopyrrolopyrrole pigment is preferable.

The content (% by mass) of the pigment in the ink is preferably 0.50% by mass or more to 10.00% by mass or less, more preferably 1.00% by mass or more to 8.00% by mass or less with respect to the total mass of the ink.

The ink includes a yellow ink containing C.I. Pigment Yellow 74. The content (% by mass) of C.I. Pigment Yellow 74 in the yellow ink is preferably 0.50% by mass or more to 10.00% by mass or less, more preferably 1.00% by mass or more to 8.00% by mass or less with respect to the total mass of the yellow ink.

Examples of a dispersion system for the pigment may include a resin-dispersed pigment using a resin (resin dispersant) as a dispersant and a self-dispersible pigment having a hydrophilic group bonded to its particle surface. In addition, a resin-bonded pigment having a resin-containing organic group chemically bonded to its particle surface, a microcapsule pigment whose particle surface is covered with, for example, a resin, or the like may be used. Of those, it is particularly preferable to use a resin-dispersed pigment using a resin dispersant having a hydrophobic portion and a hydrophilic portion so that the hydrophobic portion of the resin dispersant is adsorbed to the particle surface of the pigment and the pigment is dispersed by the hydrophilic portion.

A resin that can disperse the pigment in an aqueous medium through the action of an anionic group is preferably used as a resin dispersant. A water-soluble resin to be described later may be used as the resin dispersant. When the resin-dispersed pigment is used, the mass ratio of the content (% by mass) of the pigment in the ink to the content (% by mass) of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

### Resin

A resin such as water-soluble resin may be incorporated into the ink. The content (% by mass) of the resin in the ink is preferably 0.10% by mass or more to 20.00% by mass or less, more preferably 0.50% by mass or more to 15.00% by mass or less with respect to the total mass of the ink. The resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the resin may include a block copolymer, a random copolymer, a graft copolymer and a combination thereof. The resin may be a water-soluble resin that can be dissolved in an aqueous medium or may be a resin particle to be dispersed in the aqueous medium.

Examples of the resin may include an acrylic resin, a urethane resin and an olefin resin. Of those, an acrylic resin and a urethane resin are preferable, and an acrylic resin is more preferable. The acrylic resin preferably has, as constituent units, a hydrophilic unit as a hydrophilic part and a hydrophobic unit as a hydrophobic part. The hydrophilic unit is a unit having a hydrophilic group such as an anionic group. The hydrophilic unit may be formed by, for example, polymerizing a hydrophilic monomer having a hydrophilic group. Examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

The yellow ink preferably contains a water-soluble resin including a unit derived from styrene. C.I. Pigment Yellow 74 includes a benzene ring, and hence strongly interacts with a benzene ring derived from styrene in the water-soluble resin. Accordingly, a water-soluble resin including a unit derived from styrene is likely to adsorb to the surface of C.I. Pigment Yellow 74, and thus crystallization of C.I. Pigment Yellow 74 can be suppressed. As a result, occurrence of an adhering substance can be suppressed, and the reduction in ejection accuracy can be further suppressed. The content (% by mass) of the unit derived from styrene in the water-soluble resin is preferably 10.00% by mass or more with respect to the total mass of the water-soluble resin, more preferably 15.00% by mass or more to 30.00% by mass or less. When the content of the unit derived from styrene is less than 10.00% by mass, the adsorption of the water-soluble resin to C.I. Pigment Yellow 74 may become weak, and, in some cases, the effect of suppressing the crystallization of C.I. Pigment Yellow 74 is slightly reduced.

The urethane resin may be obtained by, for example, causing a polyisocyanate and a polyol to react with each other. In addition, a chain extender may be further caused to react with the reaction product. Examples of the olefin resin may include polyethylene and polypropylene.

The phrase “resin is water-soluble” as used herein means that when the resin is neutralized with an alkali in an amount equivalent to its acid value, the resin is present in an aqueous medium under a state in which the resin does not form any particle whose particle diameter may be measured by a dynamic light scattering method. Whether or not a resin is water-soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (based on a volume) with pure water to prepare a sample solution. Then, when the particle diameter of the resin in the sample solution is measured by a dynamic light scattering method, and a particle having a particle diameter is not measured, the resin may be determined to be water-soluble. Meanwhile, when a particle having a particle diameter is measured, the resin may be determined as “resin particle” (that is, “water dispersible resin”). Measurement conditions in this case may be set, for example, as described below.

### Measurement Conditions

Set Zero: 30 seconds
Number of times of measurement: three times
Measurement time: 180 seconds

A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions and the like are of course not limited to the foregoing.

### Aqueous Medium

The ink is an aqueous ink containing an aqueous medium that is a mixed solvent of water and a water-soluble organic solvent. Deionized water (ion-exchanged water) is preferably used as the water. The content (% by mass) of the water in the ink is preferably 50.00% by mass or more to 95.00% by mass or less with respect to the total mass of the ink.

Solvents that may be used in inks for ink jet, such as alcohols, glycols, (poly)alkylene glycols, nitrogen-containing compounds and sulfur-containing compounds, may each be used as the water-soluble organic solvent. The content (% by mass) of the water-soluble organic solvent in the ink is preferably 3.00% by mass or more to 50.00% by mass or less with respect to the total mass of the ink.

The yellow ink preferably further contains a first water-soluble organic solvent having a relative dielectric constant of 37.0 or more. In addition, the content (% by mass) of the first water-soluble organic solvent in the yellow ink is preferably 1.2 times or more to 2.0 times or less in terms of a mass ratio with respect to the content (% by mass) of C.I. Pigment Yellow 74, more preferably 1.4 times or more to 1.8 times or less. When the above-mentioned mass ratio is less than 1.2 times, the dispersed state of the pigment becomes unstable and the pigment is liable to aggregate, and thus the effect of suppressing the reduction in ejection accuracy may be reduced. Meanwhile, when the above-mentioned ratio is more than 2.0 times, the amount of the water-soluble organic solvent having a high relative dielectric constant is excessive with respect to C.I. Pigment Yellow 74. Accordingly, C.I. Pigment Yellow 74 is liable to be dissolved, and, in some cases, the amount of the adhering substance that is crystallized and precipitated is increased. Thus, in some cases, the effect of suppressing the reduction in ejection accuracy is reduced.

The content (% by mass) of the first water-soluble organic solvent in the yellow ink is preferably 5.00% by mass or more to 10.00% by mass or less with respect to the total amount of the yellow ink. Examples of the first water-soluble organic solvent may include glycerin (42.3), 2-hydroxyethyl-2-pyrrolidone (37.6), ethylene glycol (40.4) and ethylene urea (49.7) (a numerical value in parentheses represents a relative dielectric constant at 25° C.). The first water-soluble organic solvent is preferably a first water-soluble organic solvent having a vapor pressure lower than that of water, or a first water-soluble organic solvent having a relative dielectric constant of 150.0 or less.

The relative dielectric constant of the water-soluble organic solvent can be measured through use of a dielectric constant meter (e.g., product name “BI-870,” manufactured by Brookhaven Instruments Corporation or the like) under a condition of a frequency of 10 kHz. The relative dielectric constant of the water-soluble organic solvent that is a solid at 25° C. is a value calculated from the following equation (A) after the measurement of the relative dielectric constant of a 50% by mass aqueous solution thereof. Although the “water-soluble organic solvent” is typically a liquid, in the present invention, a solvent that is a solid at 25° C. (normal temperature) is also included in the category of the water-soluble organic solvent for convenience.

$${ε}_{sol} = 2 {ε}_{50 \%} - {ε}_{water} \qquad ( A )$$

εₛₒₗ: relative dielectric constant of the water-soluble organic solvent that is a solid at 25° C.
ε_{50%}: relative dielectric constant of a 50% by mass aqueous solution of the water-soluble organic solvent that is a solid at 25° C.
ε_{water}: relative dielectric constant of water

Examples of the water-soluble organic solvent that is generally used in the aqueous ink and is a solid at 25° C. may include 1,6-hexanediol, trimethylolpropane, ethylene urea, urea and polyethylene glycol having a number-average molecular weight of 1,000. In this case, the reason why the relative dielectric constant of a water-soluble organic solvent that is a solid at 25° C. is determined from the relative dielectric constant of a 50% by mass aqueous solution thereof is as described below. Of the water-soluble organic solvents that are each a solid at 25° C., some solvents that may each serve as a constituent component for the aqueous ink each have the following difficulty: it is difficult to prepare an aqueous solution having a concentration as high as more than 50% by mass. Meanwhile, in an aqueous solution having a concentration as low as 10% by mass or less, the relative dielectric constant of water becomes dominant to make it difficult to obtain a probable (effective) value of the relative dielectric constant of each of the water-soluble organic solvents. In view of the foregoing, the inventors of the present invention have made a verification. As a result, the inventors of the present invention have found that, out of the water-soluble organic solvents that were each a solid at 25° C., most solvents that could each be used in the ink enabled the preparation of aqueous solutions to be subjected to the measurement and their relative dielectric constants to be determined were each consistent with the effect of the present invention. For such reasons, the inventors of the present invention have decided to utilize a 50% by mass aqueous solution. In a case of a water-soluble organic solvent that is a solid at 25° C., the solvent having so low a solubility in water that a 50% by mass aqueous solution thereof cannot be prepared, an aqueous solution having a saturated concentration is utilized and the value of its relative dielectric constant calculated in conformity with the case where the above-mentioned εₛₒₗ is determined is used for convenience.

Examples of the other water-soluble organic solvent except the first water-soluble organic solvent having a relative dielectric constant of less than 37.0 may include trimethylolpropane (33.7), N-methyl-2-pyrrolidone (32.0), triethanolamine (31.9), diethylene glycol (31.7), 1,4-butanediol (31.1), 1,3-butanediol (30.0), 1,2-propanediol (28.8), 1,2,6-hexanetriol (28.5), 2-methyl-1,3-propanediol (28.3), 2-pyrrolidone (28.0), 1,5-pentanediol (27.0), 3-methyl-1,3-butanediol (24.0), 3-methyl-1,5-pentanediol (23.9), 1-(hydroxymethyl)-5,5-dimethylhydantoin (23.7), triethylene glycol (22.7), 1,2-butanediol (22.2), tetraethylene glycol (20.8), dipropylene glycol (19.7), polyethylene glycol having a number-average molecular weight of 200 (18.9), 2-ethyl-1,3-hexanediol (18.5), 1,3-bis(2-hydroxyethyl)-5,5-dimethylhydantoin (16.0), 1,2-hexanediol (14.8), propylene glycol monomethyl ether (12.4), polyethylene glycol having a number-average molecular weight of 600 (11.4), diethylene glycol monobutyl ether (11.0), triethylene glycol monobutyl ether (9.8), ethylene glycol monobutyl ether (9.4), tetraethylene glycol monobutyl ether (9.4), tripropylene glycol monomethyl ether (8.5), 1,6-hexanediol (7.1) and polyethylene glycol having a number-average molecular weight of 1,000 (4.6) (a numerical value in parentheses represents a relative dielectric constant at 25° C.). As the other water-soluble organic solvent, a water-soluble organic solvent having a vapor pressure lower than that of water or a water-soluble organic solvent having a relative dielectric constant of 2.0 or more is preferable.

### Surfactant

The ink preferably further contains a surfactant. Examples of the surfactant may include an anionic surfactant, a cationic surfactant, a nonionic surfactant, an amphoteric surfactant and other surfactants. Of those, a nonionic surfactant is preferably used.

Examples of the anionic surfactant may include a polyoxyethylene alkylether sulfuric acid ester salt, a polyoxyethylene alkylether sulfonic acid salt, a polyoxyethylene alkyl phenyl ether sulfuric acid ester salt, a polyoxyethylene alkyl phenyl ether sulfonic acid salt, an alpha-sulfo fatty acid ester salt, an alkylbenzene sulfonic acid salt, an alkylphenol sulfonic acid salt, an alkylnaphthalene sulfonic acid salt, an alkyltetralin sulfonic acid salt and a dialkyl sulfosuccinic acid salt. Examples of the cationic surfactant may include an alkyltrimethylammonium salt and a dialkyldimethylammonium chloride.

Examples of the nonionic surfactant include an acetylene glycol-based surfactant, a polyoxyethylene alkylether, a polyoxyethylene fatty acid ester, a polyoxyethylene alkyl phenyl ether, a fatty acid diethanol amide and a polyoxyethylene-polyoxypropylene block copolymer. An example of the amphoteric surfactant is an alkyl carboxybetaine. Examples of the other surfactant may include a fluorine-based surfactant and a silicone-based surfactant.

The content (% by mass) of the surfactant in the ink is preferably 0.10% by mass or more to 5.00% by mass or less with respect to the total amount of the ink, more preferably 0.10% by mass or more to 2.00% by mass or less.

The yellow ink preferably contains an acetylene glycol-based surfactant. The acetylene glycol-based surfactant is suitable because the balance between the additive amount to the ink and the ability to reduce the surface tension is good, and the additive amount suitable for appropriately adjusting the surface tension of the ink becomes an amount that moderately suppresses the crystallization of C.I. Pigment Yellow 74. In a case of a surfactant having an excessively high ability to reduce the surface tension, it may become difficult to add an amount that suppresses the crystallization of C.I. Pigment Yellow 74 to the ink. Meanwhile, in a case of a surfactant having an excessively low ability to reduce the surface tension, the crystallization of C.I. Pigment Yellow 74 can be suppressed, but the additive amount is increased, and hence the ink is liable to be foamed, and, in some cases, the reduction in ejection accuracy is liable to be caused. The acetylene glycol-based surfactant has a defoaming property, and hence the reduction in ejection accuracy due to the foaming is less liable to be caused even when the additive amount is increased to some extent.

The content (% by mass) of the acetylene glycol-based surfactant in the yellow ink is preferably 1.50% by mass or more to 2.50% by mass or less with respect to the total mass of the yellow ink, more preferably 1.80% by mass or more to 2.20% by mass or less. When the content of the acetylene glycol-based surfactant is less than 1.50% by mass, the acetylene glycol-based surfactant is less liable to act on C.I. Pigment Yellow 74, and the effect of suppressing the crystallization may be reduced. Meanwhile, when the content of the acetylene glycol-based surfactant is more than 2.50% by mass, in some cases, the reduction in ejection accuracy due to foaming is liable to be caused.

The content (% by mass) of the acetylene glycol-based surfactant in the yellow ink is preferably 0.3 times or more to 0.6 times or less in terms of a mass ratio with respect to the content (% by mass) of C.I. Pigment Yellow 74. In this range, the mass ratio is more preferably 0.4 times or more to 0.5 times or less. When the above-mentioned mass ratio is less than 0.3 times, the effect of suppressing the crystallization may be reduced. Meanwhile, when the above-mentioned mass ratio is more than 0.6 times, in some cases, the dispersed state of the pigment becomes unstable, and the pigment is liable to aggregate. Thus, in some cases, the reduction in ejection accuracy is liable to be caused.

The yellow ink preferably further contains a compound expressed by the following general formula (1). In the compound expressed by the general formula (1), a hydrophobic propylene oxide group interacting with the pigment is present alternately with an ethylene oxide group, and hence the compound has a large number of adsorption points to the pigment (C.I. Pigment Yellow 74), and adsorbs so as to cover the pigment. Accordingly, when the compound expressed by the general formula (1) is contained in the yellow ink, the crystallization of the pigment can be further suppressed.

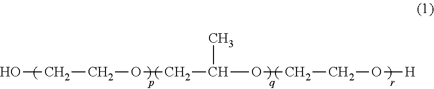

In the general formula (1), “p+r” represents a number of 3.0 or more to 27.0 or less, and “q” represents a number of 16.0 or more to 31.0 or less.

The content (% by mass) of the compound expressed by the general formula (1) in the yellow ink is preferably 0.80% by mass or more to 1.20% by mass or less with respect to the total mass of the yellow ink, more preferably 0.90% by mass or more to 1.10% by mass or less. When the content of the compound expressed by the general formula (1) is less than 0.80% by mass, the amount of the compound is too small and the compound is less liable to act on the C.I. Pigment Yellow 74. Thus, the effect of suppressing the crystallization may be reduced. Meanwhile, when the content of the compound expressed by the general formula (1) is more than 1.20% by mass, in some cases, the reduction in ejection accuracy due to foaming is liable to be caused.

The content (% by mass) of the compound expressed by the general formula (1) in the yellow ink is preferably 0.1 times or more to 0.3 times or less in terms of a mass ratio with respect to the content (% by mass) of C.I. Pigment Yellow 74. When the above-mentioned mass ratio is less than 0.1 times, the amount of the compound expressed by the general formula (1) is too small, and the effect of suppressing the crystallization may be reduced. Meanwhile, when the above-mentioned mass ratio is more than 0.3 times, in some cases, the dispersed state of the pigment becomes unstable, and the pigment is liable to aggregate. Thus, in some cases, the reduction in ejection accuracy is liable to be caused.

### Other Components

Besides the above-mentioned components, as required, the ink may also contain various additives, such as an antifoam agent, a pH adjuster, a viscosity adjuster, a rust preventive, a preservative, a fungicide, an antioxidant and a reduction inhibitor. These additives are not included in the object for measuring the relative dielectric constant.

### Physical Properties of Ink

The ink is an aqueous ink to be applied to an ink jet system. Accordingly, from the viewpoint of reliability, it is preferable that the physical property values of the ink be appropriately controlled. Specifically, the static surface tension of the ink at 25° C. is preferably 28 mN/m or more to 45 mN/m or less. In addition, the viscosity of the ink at 25° C. is preferably 1.0 mPa·s or more to 5.0 mPa·s or less, more preferably 1.0 mPa·s or more to 3.0 mPa·s or less. The pH of the ink at 25° C. is preferably 5.0 or more to 9.5 or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### Preparation of Pigment Dispersion Liquid

### (Pigment Dispersion Liquid 1)

A styrene-acrylic acid copolymer having an acid value of 120 mgKOH/g and a weight-average molecular weight of 10,000 was neutralized with a 10% potassium hydroxide aqueous solution. 10.0 Parts of C.I. Pigment Yellow 74, 3.0 parts of the neutralized styrene-acrylic acid copolymer (solid content) and 85.0 parts of ion-exchanged water were mixed to provide a mixture. The resultant mixture was dispersed through use of a sand grinder for 1 hour and then a coarse particle was removed by centrifugation treatment. Further, the supernatant was filtered with a microfilter having a pore size of 3.0 m (manufactured by FUJIFILM Corporation) under pressure to provide a pigment dispersion liquid 1 in a state in which C.I. Pigment Yellow 74 was dispersed in the water by the resin. The content of the pigment in the pigment dispersion liquid 1 was 15.00% and the content of the resin dispersant therein was 4.50%.

### (Pigment Dispersion Liquid 2)

A styrene/n-butyl acrylate/acrylic acid copolymer having an acid value of 120 mgKOH/g and a weight-average molecular weight of 10,000 was neutralized with a 10% potassium hydroxide aqueous solution. 10.0 Parts of C.I. Pigment Yellow 74, 3.0 parts of the neutralized styrene/n-butyl acrylate/acrylic acid copolymer (solid content) and 85.0 parts of ion-exchanged water were mixed to provide a mixture. The resultant mixture was dispersed through use of a sand grinder for 1 hour and then a coarse particle was removed by centrifugation treatment. Further, the supernatant was filtered with a microfilter having a pore size of 3.0 m (manufactured by FUJIFILM Corporation) under pressure to provide a pigment dispersion liquid 2 in a state in which C.I. Pigment Yellow 74 was dispersed in the water by the resin. The content of the pigment in the pigment dispersion liquid 2 was 15.00% and the content of the resin dispersant therein was 4.50%.

### (Pigment Dispersion Liquid 3)

A pigment dispersion liquid 3 was obtained similarly to the pigment dispersion liquid 1 described above except that C.I. Pigment Yellow 155 was used instead of C.I. Pigment Yellow 74. The content of the pigment in the pigment dispersion liquid 3 was 15.00% and the content of the resin dispersant therein was 4.50%.

### (Pigment Dispersion Liquid 4)

A pigment dispersion liquid 4 was obtained similarly to the pigment dispersion liquid 1 described above except that C.I. Pigment Blue 15:3 was used instead of C.I. Pigment Yellow 74. The content of the pigment in the pigment dispersion liquid 4 was 15.00% and the content of the resin dispersant therein was 4.50%.

### (Pigment Dispersion Liquid 5)

A pigment dispersion liquid 5 was obtained similarly to the pigment dispersion liquid 1 described above except that C.I. Pigment Blue 15:4 was used instead of C.I. Pigment Yellow 74. The content of the pigment in the pigment dispersion liquid 5 was 15.00% and the content of the resin dispersant therein was 4.50%.

### (Pigment Dispersion Liquid 6)

A pigment dispersion liquid 6 was obtained similarly to the pigment dispersion liquid 1 described above except that C.I. Pigment Red 122 was used instead of C.I. Pigment Yellow 74. The content of the pigment in the pigment dispersion liquid 6 was 15.00% and the content of the resin dispersant therein was 4.50%.

### (Pigment Dispersion Liquid 7)

A pigment dispersion liquid 7 was obtained similarly to the pigment dispersion liquid 1 described above except that C.I. Pigment Violet 19 was used instead of C.I. Pigment Yellow 74. The content of the pigment in the pigment dispersion liquid 7 was 15.00% and the content of the resin dispersant therein was 4.50%.

### (Pigment Dispersion Liquid 8)

A pigment dispersion liquid 8 was obtained similarly to the pigment dispersion liquid 1 described above except that C.I. Pigment Red 150 was used instead of C.I. Pigment Yellow 74. The content of the pigment in the pigment dispersion liquid 8 was 15.00% and the content of the resin dispersant therein was 4.50%.

### Preparation of Liquid Containing Dye

Each of dyes 1 to 3 described below was dissolved in ion-exchanged water to provide a liquid containing each of the dyes 1 to 3 (having a dye content of 15.00%).
Dye 1: C.I. Direct Yellow 132
Dye 2: C.I. Direct Blue 199
Dye 3: C.I. Acid Red 289

### Preparation of Water-Soluble Resin

Respective components (unit: parts) shown in Table 1 were copolymerized in accordance with an ordinary method to provide water-soluble acrylic resins 1 to 5. The resultant water-soluble acrylic resin was neutralized with potassium hydroxide whose molar amount was equivalent to the acid value of the water-soluble acrylic resin. After that, an appropriate amount of pure water was added to the solution to provide a liquid containing each of the water-soluble acrylic resins 1 to 5 in which the content of the acrylic resin (solid content) was 20.00%. The meaning of the abbreviation in Table 1 is as described below.
St: styrene
MMA: methyl methacrylate
AA: acrylic acid

TABLE 1
Preparation of water-soluble acrylic resin

| | Monomer (parts) | | |
|---|---|---|---|
| Water-soluble acrylic resin | St | MMA | AA |
| 1 | 25.0 | 55.0 | 20.0 |
| 2 | | 80.0 | 20.0 |
| 3 | 9.0 | 71.0 | 20.0 |
| 4 | 10.0 | 70.0 | 20.0 |
| 5 | 30.0 | 50.0 | 20.0 |

### Preparation of Ink

Respective components (unit: %) shown in the upper section of Table 2 (2-1 to 2-7) were mixed and sufficiently stirred. After that, the mixtures were filtered with a polypropylene filter having a pore size of 2.5 m (manufactured by Pall Corporation) under pressure to prepare respective inks. In Table 2, the numerical value added to polyethylene glycol is the number-average molecular weight. Further the terms “ACETYLENOL E100” and “ACETYLENOL E60” are both product names of acetylene glycol-based nonionic surfactants (manufactured by Kawaken Fine Chemicals Co., Ltd.). Further, the term “Pluronic (trademark) L31” is the product name of a Pluronic (trademark)-based surfactant (manufactured by ADEKA Corporation), and the term “Zonyl FS3100” is the product name of a fluorine-based surfactant (manufactured by The Chemours Company). In Table 2, the number in the parentheses added to the water-soluble organic solvent indicates the relative dielectric constant.

TABLE 2-1
Composition and characteristics of ink

| | Ink | | | | | |
|---|---|---|---|---|---|---|
| | Y1 | Y2 | Y3 | Y4 | Y5 | Y6 |
| Pigment dispersion liquid 1 | 26.67 | | 26.67 | 26.67 | 26.67 | 26.67 |
| Pigment dispersion liquid 2 | | 26.67 | | | | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | |
| Liquid containing dye 2 | | | | | | |
| Liquid containing dye 3 | | | | | | |
| Liquid containing water- | 10.00 | 10.00 | 10.00 | 10.00 | 10.00 | 10.00 |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | 6.50 | | | |
| Glycerin (42.3) | 6.50 | 6.50 | | | | |
| Ethylene glycol (40.4) | | | | 6.50 | | |
| 2-Hydroxyethyl-2- | | | | | 6.50 | |
| pyrrolidone (37.6) | | | | | | |
| Trimethylolpropane (33.7) | | | | | | 6.50 |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | 1.80 | 1.80 | 1.80 | 1.80 |
| ACETYLENOL E60 | | | | | | |
| Pluronic L31 | 0.90 | 0.90 | 0.90 | 0.90 | 0.90 | 0.90 |
| Zonyl FS3100 | | | | | | |
| Pure water | 37.13 | 37.13 | 37.13 | 37.13 | 37.13 | 37.13 |
| Content T (%) of pigment | 4.00 | 4.00 | 4.00 | 4.00 | 4.00 | 4.00 |
| Content Y (%) of C.I. | 4.00 | 4.00 | 4.00 | 4.00 | 4.00 | 4.00 |
| Pigment Yellow 74 | | | | | | |
| Content R (%) of water- | 3.20 | 3.20 | 3.20 | 3.20 | 3.20 | 3.20 |
| soluble resin | | | | | | |
| Content S (%) of first water- | 6.50 | 6.50 | 6.50 | 6.50 | 6.50 | 0.00 |
| soluble organic solvent | | | | | | |
| Content A (%) of acetylene | 1.80 | 1.80 | 1.80 | 1.80 | 1.80 | 1.80 |
| glycol-based surfactant | | | | | | |
| Content P (%) of compound | 0.90 | 0.90 | 0.90 | 0.90 | 0.90 | 0.90 |
| expressed by general | | | | | | |
| formula (1) | | | | | | |
| Value (times) of S/Y | 1.6 | 1.6 | 1.6 | 1.6 | 1.6 | 0.0 |
| Value (times) of A/Y | 0.5 | 0.5 | 0.5 | 0.5 | 0.5 | 0.5 |
| Value (times) of P/Y | 0.2 | 0.2 | 0.2 | 0.2 | 0.2 | 0.2 |

TABLE 2-2
Composition and characteristics of ink

| | Ink | | | | | |
|---|---|---|---|---|---|---|
| | Y7 | Y8 | Y9 | Y10 | Y11 | Y12 |
| Pigment dispersion liquid 1 | 26.70 | 26.67 | 26.67 | 26.67 | | 26.67 |
| Pigment dispersion liquid 2 | | | | | 26.67 | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | |
| Liquid containing dye 2 | | | | | | |
| Liquid containing dye 3 | | | | | | |
| Liquid containing water- | 10.00 | 10.00 | 10.00 | 10.00 | | |
| soluble acrylic resin 1 | | | | | | |
| Liquid containing water- | | | | | 10.00 | |
| soluble acrylic resin 2 | | | | | | |
| Liquid containing water- | | | | | | 10.00 |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | | | | |
| Glycerin (42.3) | 4.30 | 4.80 | 8.00 | 8.50 | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | 1.80 | 1.80 | 1.80 | 1.80 |
| ACETYLENOL E60 | | | | | | |
| Pluronic L31 | 0.90 | 0.90 | 0.90 | 0.90 | 0.90 | 0.90 |
| Zonyl FS3100 | | | | | | |
| Pure water | 39.30 | 38.83 | 35.63 | 35.13 | 37.13 | 37.13 |
| Content T (%) of pigment | 4.01 | 4.00 | 4.00 | 4.00 | 4.00 | 4.00 |
| Content Y (%) of C.I. | 4.01 | 4.00 | 4.00 | 4.00 | 4.00 | 4.00 |
| Pigment Yellow 74 | | | | | | |
| Content R (%) of water- | 3.20 | 3.20 | 3.20 | 3.20 | 3.20 | 3.20 |
| soluble resin | | | | | | |
| Content S (%) of first water- | 4.30 | 4.80 | 8.00 | 8.50 | 6.50 | 6.50 |
| soluble organic solvent | | | | | | |
| Content A (%) of acetylene | 1.80 | 1.80 | 1.80 | 1.80 | 1.80 | 1.80 |
| glycol-based surfactant | | | | | | |
| Content P (%) of compound | 0.90 | 0.90 | 0.90 | 0.90 | 0.90 | 0.90 |
| expressed by general | | | | | | |
| formula (1) | | | | | | |
| Value (times) of S/Y | 1.1 | 1.2 | 2.0 | 2.1 | 1.6 | 1.6 |
| Value (times) of A/Y | 0.4 | 0.5 | 0.5 | 0.5 | 0.5 | 0.5 |
| Value (times) of P/Y | 0.2 | 0.2 | 0.2 | 0.2 | 0.2 | 0.2 |

TABLE 2-3
Composition and characteristics of ink

| | Ink | | | | | |
|---|---|---|---|---|---|---|
| | Y13 | Y14 | Y15 | Y16 | Y17 | Y18 |
| Pigment dispersion liquid 1 | 26.67 | 26.67 | 26.67 | 26.67 | 26.67 | 26.67 |
| Pigment dispersion liquid 2 | | | | | | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | |
| Liquid containing dye 2 | | | | | | |
| Liquid containing dye 3 | | | | | | |
| Liquid containing water- | | | 10.00 | 10.00 | 10.00 | 10.00 |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | 10.00 | | | | | |
| soluble acrylic resin 4 | | | | | | |
| Liquid containing water- | | 10.00 | | | | |
| soluble acrylic resin 5 | | | | | | |
| Ethylene urea (49.7) | | | | | | |
| Glycerin (42.3) | 6.50 | 6.50 | 6.50 | 6.50 | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | | | 1.40 | 1.50 |
| ACETYLENOL E60 | | | 1.80 | | | |
| Pluronic L31 | 0.90 | 0.90 | 0.90 | 0.90 | 0.90 | 0.90 |
| Zonyl FS3100 | | | | 1.80 | | |
| Pure water | 37.13 | 37.13 | 37.13 | 37.13 | 37.53 | 37.43 |
| Content T (%) of pigment | 4.00 | 4.00 | 4.00 | 4.00 | 4.00 | 4.00 |
| Content Y (%) of C.I. | 4.00 | 4.00 | 4.00 | 4.00 | 4.00 | 4.00 |
| Pigment Yellow 74 | | | | | | |
| Content R (%) of water- | 3.20 | 3.20 | 3.20 | 3.20 | 3.20 | 3.20 |
| soluble resin | | | | | | |
| Content S (%) of first water- | 6.50 | 6.50 | 6.50 | 6.50 | 6.50 | 6.50 |
| soluble organic solvent | | | | | | |
| Content A (%) of acetylene | 1.80 | 1.80 | 1.80 | 0.00 | 1.40 | 1.50 |
| glycol-based surfactant | | | | | | |
| Content P (%) of compound | 0.90 | 0.90 | 0.90 | 0.90 | 0.90 | 0.90 |
| expressed by general | | | | | | |
| formula (1) | | | | | | |
| Value (times) of S/Y | 1.6 | 1.6 | 1.6 | 1.6 | 1.6 | 1.6 |
| Value (times) of A/Y | 0.5 | 0.5 | 0.5 | 0.0 | 0.4 | 0.4 |
| Value (times) of P/Y | 0.2 | 0.2 | 0.2 | 0.2 | 0.2 | 0.2 |

TABLE 2-4
Composition and characteristics of ink

| | Ink | | | | | |
|---|---|---|---|---|---|---|
| | Y19 | Y20 | Y21 | Y22 | Y23 | Y24 |
| Pigment dispersion liquid 1 | 26.67 | 26.67 | 41.00 | 40.00 | 22.00 | 23.00 |
| Pigment dispersion liquid 2 | | | | | | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | |
| Liquid containing dye 2 | | | | | | |
| Liquid containing dye 3 | | | | | | |
| Liquid containing water- | 10.00 | 10.00 | 10.00 | 10.00 | 10.00 | 10.00 |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | | | | |
| Glycerin (42.3) | 6.50 | 6.50 | 7.50 | 7.50 | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 2.50 | 2.60 | 1.50 | 2.00 | 2.00 | 2.50 |
| ACETYLENOL E60 | | | | | | |
| Pluronic L31 | 0.90 | 0.90 | 0.90 | 0.90 | 0.90 | 0.90 |
| Zony1 FS3100 | | | | | | |
| Pure water | 36.43 | 36.33 | 22.10 | 22.60 | 41.60 | 40.10 |
| Content T (%) of pigment | 4.00 | 4.00 | 6.15 | 6.00 | 3.30 | 3.45 |
| Content Y (%) of C.I. | 4.00 | 4.00 | 6.15 | 6.00 | 3.30 | 3.45 |
| Pigment Yellow 74 | | | | | | |
| Content R (%) of water- | 3.20 | 3.20 | 3.85 | 3.80 | 2.99 | 3.04 |
| soluble resin | | | | | | |
| Content S (%) of first water- | 6.50 | 6.50 | 7.50 | 7.50 | 6.50 | 6.50 |
| soluble organic solvent | | | | | | |
| Content A (%) of acetylene | 2.50 | 2.60 | 1.50 | 2.00 | 2.00 | 2.50 |
| glycol-based surfactant | | | | | | |
| Content P (%) of compound | 0.90 | 0.90 | 0.90 | 0.90 | 0.90 | 0.90 |
| expressed by general | | | | | | |
| formula (1) | | | | | | |
| Value (times) of S/Y | 1.6 | 1.6 | 1.2 | 1.3 | 2.0 | 1.9 |
| Value (times) of A/Y | 0.6 | 0.7 | 0.2 | 0.3 | 0.6 | 0.7 |
| Value (times) of P/Y | 0.2 | 0.2 | 0.1 | 0.2 | 0.3 | 0.3 |

TABLE 2-5
Composition and characteristics of ink

| | Ink | | | | | |
|---|---|---|---|---|---|---|
| | Y25 | Y26 | Y27 | Y28 | Y29 | Y30 |
| Pigment dispersion liquid 1 | 26.67 | 26.67 | 26.67 | 26.67 | 26.67 | 30.00 |
| Pigment dispersion liquid 2 | | | | | | |
| Pigment dispersion liquid 3 | | | | | | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | |
| Liquid containing dye 2 | | | | | | |
| Liquid containing dye 3 | | | | | | |
| Liquid containing water- | 10.00 | 10.00 | 10.00 | 10.00 | 10.00 | 10.00 |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | | | | |
| Glycerin (42.3) | 6.50 | 6.50 | 6.50 | 6.50 | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | 1.80 | 1.80 | 1.80 | 1.80 |
| ACETYLENOL E60 | | | | | | |
| Pluronic L31 | | 0.70 | 0.80 | 1.20 | 1.30 | 0.20 |
| Zonyl FS3100 | | | | | | |
| Pure water | 38.03 | 37.33 | 37.23 | 36.83 | 36.73 | 34.50 |
| Content T (%) of pigment | 4.00 | 4.00 | 4.00 | 4.00 | 4.00 | 4.50 |
| Content Y (%) of C.I. | 4.00 | 4.00 | 4.00 | 4.00 | 4.00 | 4.50 |
| Pigment Yellow 74 | | | | | | |
| Content R (%) of water- | 3.20 | 3.20 | 3.20 | 3.20 | 3.20 | 3.35 |
| soluble resin | | | | | | |
| Content S (%) of first water- | 6.50 | 6.50 | 6.50 | 6.50 | 6.50 | 6.50 |
| soluble organic solvent | | | | | | |
| Content A (%) of acetylene | 1.80 | 1.80 | 1.80 | 1.80 | 1.80 | 1.80 |
| glycol-based surfactant | | | | | | |
| Content P (%) of compound | 0.00 | 0.70 | 0.80 | 1.20 | 1.30 | 0.20 |
| expressed by general | | | | | | |
| formula (1) | | | | | | |
| Value (times) of S/Y | 1.6 | 1.6 | 1.6 | 1.6 | 1.6 | 1.4 |
| Value (times) of A/Y | 0.5 | 0.5 | 0.5 | 0.5 | 0.5 | 0.4 |
| Value (times) of P/Y | 0.0 | 0.2 | 0.2 | 0.3 | 0.3 | 0.00 |

TABLE 2-6
Composition and characteristics of ink

| | Ink | | | | | |
|---|---|---|---|---|---|---|
| | Y31 | Y32 | Y33 | Y34 | Y35 | Y36 |
| Pigment dispersion liquid 1 | 26.67 | 26.67 | 26.67 | | | |
| Pigment dispersion liquid 2 | | | | 26.67 | | |
| Pigment dispersion liquid 3 | | | | | 26.67 | |
| Pigment dispersion liquid 4 | | | | | | |
| Pigment dispersion liquid 5 | | | | | | |
| Pigment dispersion liquid 6 | | | | | | |
| Pigment dispersion liquid 7 | | | | | | |
| Pigment dispersion liquid 8 | | | | | | |
| Liquid containing dye 1 | | | | | | 26.67 |
| Liquid containing dye 2 | | | | | | |
| Liquid containing dye 3 | | | | | | |
| Liquid containing water- | 10.00 | 10.00 | 10.00 | | 10.00 | |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | | | | |
| Glycerin (42.3) | 6.50 | 6.50 | 6.50 | | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | 6.50 | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | 1.80 | | 1.80 | 1.80 |
| ACETYLENOL E60 | | | | | | |
| Pluronic L31 | 0.40 | 1.20 | 1.60 | | 0.90 | 0.90 |
| Zonyl FS3100 | | | | | | |
| Pure water | 37.63 | 36.83 | 36.43 | 49.83 | 37.13 | 47.13 |
| Content T (%) of pigment | 4.00 | 4.00 | 4.00 | 4.00 | 4.00 | 0.00 |
| Content Y (%) of C.I. | 4.00 | 4.00 | 4.00 | 4.00 | 0.00 | 0.00 |
| Pigment Yellow 74 | | | | | | |
| Content R (%) of water- | 3.20 | 3.20 | 3.20 | 1.20 | 3.20 | 0.00 |
| soluble resin | | | | | | |
| Content S (%) of first water- | 6.50 | 6.50 | 6.50 | 0.00 | 6.50 | 6.50 |
| soluble organic solvent | | | | | | |
| Content A (%) of acetylene | 1.80 | 1.80 | 1.80 | 0.00 | 1.80 | 1.80 |
| glycol-based surfactant | | | | | | |
| Content P (%) of compound | 0.40 | 1.20 | 1.60 | 0.00 | 0.90 | 0.90 |
| expressed by general | | | | | | |
| formula (1) | | | | | | |
| Value (times) of S/Y | 1.6 | 1.6 | 1.6 | 0.0 | — | — |
| Value (times) of A/Y | 0.5 | 0.5 | 0.5 | 0.0 | — | — |
| Value (times) of P/Y | 0.1 | 0.3 | 0.4 | 0.0 | — | — |

TABLE 2-7
Composition and characteristics of ink

| | Ink | | | | | |
|---|---|---|---|---|---|---|
| | C1 | C2 | C3 | M1 | M2 | M3 |
| Pigment dispersion liquid 1 | | | | | | |
| Pigment dispersion liquid 2 | | | | | | |
| Pigment dispersion liquid 3 | | | | | | |
| Pigment dispersion liquid 4 | 33.33 | | | | | |
| Pigment dispersion liquid 5 | | 33.33 | | | | |
| Pigment dispersion liquid 6 | | | | 23.33 | | |
| Pigment dispersion liquid 7 | | | | | 23.33 | |
| Pigment dispersion liquid 8 | | | | 10.00 | 10.00 | |
| Liquid containing dye 1 | | | | | | |
| Liquid containing dye 2 | | | 26.67 | | | |
| Liquid containing dye 3 | | | | | | 26.67 |
| Liquid containing water- | 10.00 | 10.00 | | 10.00 | 10.00 | |
| soluble acrylic resin 1 | | | | | | |
| Liquid containing water- | | | | | | |
| soluble acrylic resin 2 | | | | | | |
| Liquid containing water- | | | | | | |
| soluble acrylic resin 3 | | | | | | |
| Liquid containing water- | | | | | | |
| soluble acrylic resin 4 | | | | | | |
| Liquid containing water- | | | | | | |
| soluble acrylic resin 5 | | | | | | |
| Ethylene urea (49.7) | | | | | | |
| Glycerin (42.3) | 6.50 | 6.50 | 6.50 | 6.50 | 6.50 | 6.50 |
| Ethylene glycol (40.4) | | | | | | |
| 2-Hydroxyethyl-2- | | | | | | |
| pyrrolidone (37.6) | | | | | | |
| Trimethylolpropane (33.7) | | | | | | |
| Triethylene glycol (22.7) | 13.00 | 13.00 | 13.00 | 13.00 | 13.00 | 13.00 |
| 1,2-Hexanediol (14.8) | 2.00 | 2.00 | 2.00 | 2.00 | 2.00 | 2.00 |
| Polyethylene Glycol | 2.00 | 2.00 | 2.00 | 2.00 | 2.00 | 2.00 |
| 1000 (4.6) | | | | | | |
| ACETYLENOL E100 | 1.80 | 1.80 | 1.80 | 1.80 | 1.80 | 1.80 |
| ACETYLENOL E60 | | | | | | |
| Pluronic L31 | 0.90 | 0.90 | 0.90 | 0.90 | 0.90 | 0.90 |
| Zonyl FS3100 | | | | | | |
| Pure water | 30.47 | 30.47 | 47.13 | 30.47 | 30.47 | 47.13 |
| Content T (%) of pigment | 5.00 | 5.00 | 0.00 | 5.00 | 5.00 | 0.00 |
| Content Y (%) of C.I. | 0.00 | 0.00 | 0.00 | 0.00 | 0.00 | 0.00 |
| Pigment Yellow 74 | | | | | | |
| Content R (%) of water- | 3.50 | 3.50 | 0.00 | 3.50 | 3.50 | 0.00 |
| soluble resin | | | | | | |
| Content S (%) of first water- | 6.50 | 6.50 | 6.50 | 6.50 | 6.50 | 6.50 |
| soluble organic solvent | | | | | | |
| Content A (%) of acetylene | 1.80 | 1.80 | 1.80 | 1.80 | 1.80 | 1.80 |
| glycol-based surfactant | | | | | | |
| Content P (%) of compound | 0.90 | 0.90 | 0.90 | 0.90 | 0.90 | 0.90 |
| expressed by general | | | | | | |
| formula (1) | | | | | | |
| Value (times) of S/Y | — | — | — | — | — | — |
| Value (times) of A/Y | — | — | — | — | — | — |
| Value (times) of P/Y | — | — | — | — | — | — |

### Configuration of Recording Unit

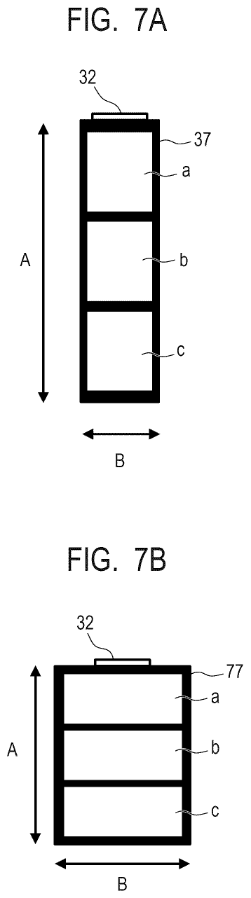

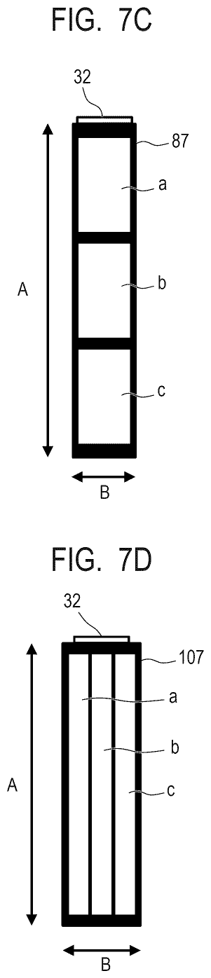

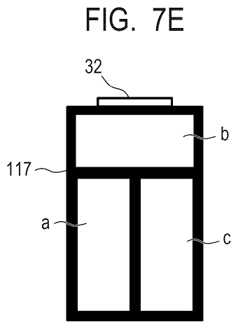

A recording head employing a system of ejecting an ink by applying thermal energy was prepared. In the recording element substrate forming the recording head, an ejection orifice array formed of 384 ejection orifices arrayed at an array density of 600 dpi is arranged. The mass of an ink droplet ejected from one ejection orifice is 5.5 ng. Further, thermoplastic resin compositions were respectively molded to provide recording units 1 to 9 having ink storage portions arranged in the manner illustrated in FIG. 7A to FIG. 7E. As the thermoplastic resin composition, there was used a thermoplastic resin composition obtained by adding, as the filler material, 25 parts of E-glass chopped strand having a length of 5 mm to 100 parts of a thermoplastic resin being a mixture of a styrene-based resin and polyphenylene ether. The characteristics of the obtained recording units are shown in Table 3.

In the ink storage portion 37 illustrated in FIG. 7A, three storage parts “a” to “c” are arrayed in a direction orthogonal to a scanning direction of the recording head. In an ink storage portion 77 illustrated in FIG. 7B, three storage parts “a” to “c” are arrayed in a direction orthogonal to a scanning direction of the recording head. In an ink storage portion 87 illustrated in FIG. 7C, three storage parts “a” to “c” are arrayed in a direction orthogonal to a scanning direction of the recording head. In an ink storage portion 107 illustrated in FIG. 7D, three storage parts “a” to “c” are arrayed in a direction parallel to the scanning direction of the recording head. In an ink storage portion 117 illustrated in FIG. 7E, three storage parts “a” to “c” are arranged in a T-shape instead of being arranged in one direction. Ink storage portions 7 and 8 shown in Table 3 were obtained by molding a thermoplastic resin that was a mixture of a styrene-based resin and polyphenylene ether, that is, a thermoplastic resin having no filler material added thereto. In addition, the recording head was bonded to the obtained ink storage portion without intermediation of any other member to manufacture the recording unit.

TABLE 3
Characteristics of recording units

| Recording unit | Filler material | Shape | Ratio A/B |
|---|---|---|---|
| 1 | Present | FIG. 7A | 3.0 |
| 2 | Present | FIG. 7B | 1.5 |
| 3 | Present | FIG. 7B | 2.0 |
| 4 | Present | FIG. 7C | 4.0 |
| 5 | Present | FIG. 7C | 4.5 |
| 6 | Present | FIG. 7D | 3.0 |
| 7 | Absent | FIG. 7A | 3.0 |
| 8 | Absent | FIG. 7E | — |
| 9 | Present | FIG. 7E | — |

### Evaluation

### (Ink Jet Recording Apparatus)

A product name “PIXUS TS5130S” (manufactured by Canon Inc.) was prepared as an apparatus 1 as an ink jet recording apparatus of a type in which, when an ink stored inside of the ink storage portion (ink cartridge) has been consumed, the ink storage portion is replaced with a new ink storage portion filled with the ink. Further, a product name “G3370” (manufactured by Canon Inc.) was prepared as an apparatus 2 as an ink jet recording apparatus of a type in which an ink storage portion (sub tank) on a carriage and an ink storage portion (main tank) placed in the apparatus are connected to each other by a tube through which the ink flows. Those apparatus were modified to allow the prepared recording unit described above to be mounted thereon. In this Example, the recording duty of a solid image recorded under the following condition is defined as 100%: two ink droplets having a mass per droplet of 5.5 ng are applied to a unit region measuring 1/600 inch by 1/600 inch. In the present invention, in evaluation criteria for each of the following items, while levels “A” and “B” were defined as acceptable levels, a level “C” was defined as an unacceptable level. The evaluation results are shown in Table 4 (Table 4-1 to Table 4-4). In Table 3, symbols (“a” to “c”) indicating the positions of the inks of the respective colors correspond to symbols (“a” to “c”) in FIG. 7A to FIG. 7E.

### (Strength of Ink Storage Portion)

In order to promote deformation by the heat of the ink storage portion (casing), the recording unit was stored for 1 month under an environment at a temperature of 60° C. Under a state in which the upper surface of the ink storage portion was directed downward in the gravity direction and the ejection orifice surface of the recording head was directed upward, the recording unit was dropped twice on a lauan material from a height of 80 cm. The ink storage portion of the recording unit after dropping was visually observed, and the strength of the ink storage portion was evaluated in accordance with the evaluation criteria shown below.

A: No cracking or chipping of the ink storage portion occurred.

B: Cracking or chipping of the ink storage portion occurred, but no ink leakage was observed.

C: Cracking or chipping of the ink storage portion occurred, and ink leakage was observed.

### (Ejection Characteristic)

After electrical pulses were applied a predetermined number of times to the heater of the recording head of the ink jet recording apparatus described above, a nozzle check pattern of “Pixus TS5130S” or “G3370” was recorded through use of a magenta ink and a yellow ink with a drive frequency of 24 kHz. The states of the ejection misdirection and the dot deformation caused in the recorded nozzle check pattern were visually observed, and the ejection characteristic at the time of high frequency drive was evaluated in accordance with the evaluation criteria shown below.

AA: When electrical pulses of 2.0×10⁸ times or more were applied, the magenta ink and the yellow ink had the difference of less than 10 in the number of ejection orifices in which the ejection misdirection and the dot deformation were caused.

A: When electrical pulses of 1.5×10⁸ times or more to less than 2.0×10⁸ times were applied, the magenta ink and the yellow ink had the difference of 10 or more in the number of ejection orifices in which the ejection misdirection and the dot deformation were caused.

B: When electrical pulses of 1.0×10⁸ times or more to less than 1.5×10⁸ times were applied, the magenta ink and the yellow ink had the difference of 10 or more in the number of ejection orifices in which the ejection misdirection and the dot deformation were caused.

C: When electrical pulses of less than 1.0×10⁸ times were applied, as compared to the magenta ink, the yellow ink had the difference of 10 or more in the number of ejection orifices in which the ejection misdirection and the dot deformation were caused.

### (Color Developability of Image)

Through use of the ink jet recording apparatus described above, a solid image of 2 cm×2 cm having a recording duty of 100% was recorded with the yellow ink on a recording medium (PPC sheet, product name “CS-680,” manufactured by Canon Inc.). The recording environment was set to a temperature of 25° C. and a relative humidity of 50%. Through use of a spectrophotometer (product name “Spectorolino,” manufactured by Gretag Macbeth GmbH), the optical density of the recorded solid image was measured under conditions of a light source of D50 and a visual field of 2°. Then, the color developability of the image was evaluated in accordance with the evaluation criteria shown below.

A: The optical density was 0.90 or more.

C: The optical density was less than 0.90.

### (Apparatus Size)

The apparatus 1 or 2 was modified so as to allow the recording unit to be mounted thereon. Then, the sizes of the apparatus before and after the modification were compared to evaluate the apparatus size in accordance with the evaluation criteria shown below.

A: Downsizing was achieved through modification.

B: An equivalent size was obtained through modification.

C: The size was increased through modification.

TABLE 4-1
Evaluation conditions

| | | | Recording unit | | | |
|---|---|---|---|---|---|---|
| | | Kind of | | Position of | Position of | Position of |
| | | apparatus | Kind | yellow ink | cyan ink | magenta ink |
| Example | 1 | 1 | 1 | b | c | a |
| | 2 | 1 | 1 | b | c | a |
| | 3 | 1 | 1 | b | c | a |
| | 4 | 1 | 1 | b | c | a |
| | 5 | 1 | 1 | b | c | a |
| | 6 | 1 | 1 | b | c | a |
| | 7 | 1 | 1 | b | c | a |
| | 8 | 1 | 1 | b | c | a |
| | 9 | 1 | 1 | b | c | a |
| | 10 | 1 | 1 | b | c | a |
| | 11 | 1 | 1 | b | c | a |
| | 12 | 1 | 1 | b | c | a |
| | 13 | 1 | 1 | b | c | a |
| | 14 | 1 | 1 | b | c | a |
| | 15 | 1 | 1 | b | c | a |
| | 16 | 1 | 1 | b | c | a |
| | 17 | 1 | 1 | b | c | a |
| | 18 | 1 | 1 | b | c | a |
| | 19 | 1 | 1 | b | c | a |
| | 20 | 1 | 1 | b | c | a |
| | 21 | 1 | 1 | b | c | a |
| | 22 | 1 | 1 | b | c | a |
| | 23 | 1 | 1 | b | c | a |
| | 24 | 1 | 1 | b | c | a |
| | 25 | 1 | 1 | b | c | a |
| | 26 | 1 | 1 | b | c | a |
| | 27 | 1 | 1 | b | c | a |

TABLE 4-2
Evaluation conditions and evaluation results

| | | Kind of ink | | | Evaluation Results | | | |
|---|---|---|---|---|---|---|---|---|
| | | Yellow | Cyan | Magenta | | Ejection | Color | Apparatus |
| | | ink | ink | ink | Strength | characteristic | developability | size |
| Example | 1 | Y1 | C1 | M1 | A | AA | A | A |
| | 2 | Y2 | C1 | M1 | A | AA | A | A |
| | 3 | Y1 | C2 | M1 | A | AA | A | A |
| | 4 | Y1 | C1 | M2 | A | AA | A | A |
| | 5 | Y1 | C2 | M2 | A | AA | A | A |
| | 6 | Y3 | C1 | M1 | A | AA | A | A |
| | 7 | Y4 | C1 | M1 | A | AA | A | A |
| | 8 | Y5 | C1 | M1 | A | AA | A | A |
| | 9 | Y6 | C1 | M1 | A | B | A | A |
| | 10 | Y7 | C1 | M1 | A | A | A | A |
| | 11 | Y8 | C1 | M1 | A | AA | A | A |
| | 12 | Y9 | C1 | M1 | A | AA | A | A |
| | 13 | Y10 | C1 | M1 | A | A | A | A |
| | 14 | Y11 | C1 | M1 | A | B | A | A |
| | 15 | Y12 | C1 | M1 | A | A | A | A |
| | 16 | Y13 | C1 | M1 | A | AA | A | A |
| | 17 | Y14 | C1 | M1 | A | AA | A | A |
| | 18 | Y15 | C1 | M1 | A | AA | A | A |
| | 19 | Y16 | C1 | M1 | A | B | A | A |
| | 20 | Y17 | C1 | M1 | A | A | A | A |
| | 21 | Y18 | C1 | M1 | A | AA | A | A |
| | 22 | Y19 | C1 | M1 | A | AA | A | A |
| | 23 | Y20 | C1 | M1 | A | A | A | A |
| | 24 | Y21 | C1 | M1 | A | A | A | A |
| | 25 | Y22 | C1 | M1 | A | AA | A | A |
| | 26 | Y23 | C1 | M1 | A | AA | A | A |
| | 27 | Y24 | C1 | M1 | A | A | A | A |

TABLE 4-3
Evaluation conditions

| | | | Recording unit | | | |
|---|---|---|---|---|---|---|
| | | Kind of | | Position of | Position of | Position of |
| | | apparatus | Kind | yellow ink | cyan ink | magenta ink |
| Example | 28 | 1 | 1 | b | c | a |
| | 29 | 1 | 1 | b | c | a |
| | 30 | 1 | 1 | b | c | a |
| | 31 | 1 | 1 | b | c | a |
| | 32 | 1 | 1 | b | c | a |
| | 33 | 1 | 1 | b | c | a |
| | 34 | 1 | 1 | b | c | a |
| | 35 | 1 | 1 | b | c | a |
| | 36 | 1 | 1 | b | c | a |
| | 37 | 1 | 2 | b | c | a |
| | 38 | 1 | 3 | b | c | a |
| | 39 | 1 | 4 | b | c | a |
| | 40 | 1 | 5 | b | c | a |
| | 41 | 1 | 6 | b | c | a |
| | 42 | 2 | 1 | b | c | a |
| | 43 | 1 | 1 | b | c | a |
| Compar- | 1 | 1 | 7 | b | c | a |
| ative | 2 | 1 | 7 | b | c | a |
| Example | 3 | 1 | 8 | b | c | a |
| | 4 | 1 | 9 | b | c | a |
| | 5 | 1 | 9 | b | c | a |
| | 6 | 1 | 1 | a | c | b |
| | 7 | 1 | 1 | a | c | b |
| | 8 | 1 | 6 | b | c | a |
| Reference | 1 | 1 | 9 | b | c | a |
| Example | 2 | 1 | 1 | a | c | b |
| | 3 | 1 | 1 | b | a | c |
| | 4 | 1 | 1 | c | b | a |

TABLE 4-4
Evaluation conditions and evaluation results

| | | Kind of ink | | | Evaluation Result | | | |
|---|---|---|---|---|---|---|---|---|
| | | Yellow | Cyan | Magenta | | Ejection | Color | Apparatus |
| | | Ink | Ink | Ink | Strength | characteristic | developability | size |
| Example | 28 | Y25 | C1 | M1 | A | B | A | A |
| | 29 | Y26 | C1 | M1 | A | A | A | A |
| | 30 | Y27 | C1 | M1 | A | AA | A | A |
| | 31 | Y28 | C1 | M1 | A | AA | A | A |
| | 32 | Y29 | C1 | M1 | A | A | A | A |
| | 33 | Y30 | C1 | M1 | A | B | A | A |
| | 34 | Y31 | C1 | M1 | A | A | A | A |
| | 35 | Y32 | C1 | M1 | A | AA | A | A |
| | 36 | Y33 | C1 | M1 | A | B | A | A |
| | 37 | Y1 | C1 | M1 | A | AA | A | B |
| | 38 | Y1 | C1 | M1 | A | AA | A | A |
| | 39 | Y1 | C1 | M1 | A | AA | A | A |
| | 40 | Y1 | C1 | M1 | B | AA | A | A |
| | 41 | Y1 | C1 | M1 | B | AA | A | A |
| | 42 | Y1 | C1 | M1 | A | AA | A | A |
| | 43 | Y34 | C1 | M1 | A | B | A | A |
| Comparative | 1 | Y1 | C1 | M1 | C | AA | A | A |
| Example | 2 | Y35 | C1 | M1 | C | AA | C | A |
| | 3 | Y1 | C1 | M1 | C | AA | A | A |
| | 4 | Y1 | C1 | M1 | A | C | A | A |
| | 5 | Y35 | C1 | M1 | A | AA | C | A |
| | 6 | Y35 | C1 | M1 | A | AA | C | A |
| | 7 | Y1 | C1 | M1 | A | C | A | A |
| | 8 | Y1 | C1 | M1 | A | C | A | A |
| Reference | 1 | Y36 | C3 | M3 | A | AA | A | A |
| Example | 2 | Y36 | C3 | M3 | A | AA | A | A |
| | 3 | Y36 | C3 | M3 | A | AA | A | A |
| | 4 | Y36 | C3 | M3 | A | AA | A | A |

The ejection characteristic of Example 43 was relatively degraded as compared to other Examples having B rank.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-128301, filed Aug. 7, 2023, and Japanese Patent Application No. 2024-117456, filed Jul. 23, 2024, which are hereby incorporated by reference herein in their entirety.

What is claimed is:

1. An ink jet recording method using an ink jet recording apparatus, the ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion by an action of thermal energy,
the ink jet recording method comprising recording an image by applying the aqueous ink ejected from the ejection orifice to a recording medium,
wherein the ink storage portion comprises three or more storage parts divided independently of each other, and the three or more storage parts are arrayed in one predetermined direction,
wherein the aqueous ink comprises a yellow ink comprising C.I. Pigment Yellow 74, and
wherein the yellow ink is stored in a corresponding one of the three or more storage parts arranged on an inner side.

2. The ink jet recording method according to claim 1, wherein the yellow ink further comprises a first water-soluble organic solvent having a relative dielectric constant of 37.0 or more, and a content (% by mass) of the first water-soluble organic solvent in the yellow ink is 1.2 times or more to 2.0 times or less in terms of a mass ratio with respect to a content (% by mass) of the C.I. Pigment Yellow 74.

3. The ink jet recording method according to claim 1, wherein the yellow ink further comprises a water-soluble resin comprising a unit derived from styrene.

4. The ink jet recording method according to claim 3, wherein a content (% by mass) of the unit derived from the styrene in the water-soluble resin is 10.00% by mass or more with respect to a total mass of the water-soluble resin.

5. The ink jet recording method according to claim 1, wherein the yellow ink further comprises an acetylene glycol-based surfactant, and a content (% by mass) of the acetylene glycol-based surfactant in the yellow ink is 1.50% by mass or more to 2.50% by mass or less with respect to a total mass of the yellow ink.

6. The ink jet recording method according to claim 5, wherein the content (% by mass) of the acetylene glycol-based surfactant in the yellow ink is 0.3 times or more to 0.6 times or less in terms of a mass ratio with respect to a content (% by mass) of the C.I. Pigment Yellow 74.

7. The ink jet recording method according to claim 1, wherein the yellow ink further comprises a compound expressed by the following general formula (1), and a content (% by mass) of the compound expressed by the following general formula (1) in the yellow ink is 0.80% by mass or more to 1.20% by mass or less with respect to a total mass of the yellow ink: 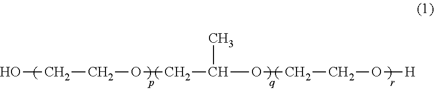
in the general formula (1), “p+r” represents a number of 3.0 or more to 27.0 or less, and “q” represents a number of 16.0 or more to 31.0 or less.

8. The ink jet recording method according to claim 7, wherein the content (% by mass) of the compound expressed by the general formula (1) in the yellow ink is 0.1 times or more to 0.3 times or less in terms of a mass ratio with respect to a content (% by mass) of the C.I. Pigment Yellow 74.

9. The ink jet recording method according to claim 1, wherein the recording head has formed therein an ejection orifice array in which a plurality of the ejection orifices is arrayed in parallel to a longitudinal direction of the ink storage portion, and the ink storage portion has a ratio (A/B) of a length A in the longitudinal direction to a length B in a transverse direction orthogonal to the longitudinal direction, the ratio (A/B) being 2.0 times or more to 4.0 times or less.

10. The ink jet recording method according to claim 1, wherein the ink storage portion is replaced with another ink storage portion after the aqueous ink stored therein has been consumed.

11. The ink jet recording method according to claim 1, wherein the ink jet recording apparatus further comprises:
a second ink storage portion having a capacity larger than a capacity of the ink storage portion; and
a tube through which the aqueous ink flows between the second ink storage portion and the ink storage portion.

12. An ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion by an action of thermal energy,
wherein the ink storage portion comprises three or more storage parts divided independently of each other, and the three or more storage parts are arrayed in one predetermined direction,
wherein the aqueous ink comprises a yellow ink comprising C.I. Pigment Yellow 74, and
wherein the yellow ink is stored in a corresponding one of the three or more storage parts arranged on an inner side.
